(19) United States
(12) Patent Application Publication
(10) Pub. No.: US 2026/0024977 A1
(43) Pub. Date: Jan. 22, 2026

(54) Connector for attaching a cable or pipe to a support structure

(71) Applicant: Hilti Aktiengesellschaft, Schaan (LI)

(72) Inventor: Shuai WANG, Shanghai (CN)

(21) Appl. No.: 18/997,236

(22) PCT Filed: Jul. 20, 2023
(86) PCT No.: PCT/EP2023/070193

§ 371 Date: Jan. 21, 2025

(30) Foreign Application Priority Data
Aug. 1, 2022 (CN) 202210914377.2

(51) Int. Cl. H02G 3/32; F16B 5/02; F16L 3/02

(52) U.S. Cl. CPC H02G 3/32; F16B 5/0208; F16L 3/02

(57) ABSTRACT

A connector (1) for attaching a cable or pipe to a support structure, the connector (1) including an installation part (2) for fastening to the support structure and a clamping part (3) for supporting the cable or pipe, the installation part (2) including a base (21) substantially perpendicular to the fastening direction (D) and a sidewall (22) extending from a side edge of the base (21) substantially in the fastening direction (D); the installation part (2) further includes an adapter part (20) for receiving the fastening component, and the base (21) is provided with an opening (23); the adapter part (20) is at least partially installed in the opening (23), and when the adapter part (20) is fastened to the support structure, the base (21) is movable relative to the adapter part (20). The connector (1) is fastened to the support structure by the adapter part (20), and the opening (23) in the base (21) enables the base (21) to move within a certain range relative to the fixed adapter part (20), thus making the connector (1) position-adjustable.

The present invention relates to an installation and fastening component, in particular to a connector for attaching a cable or pipe to a support structure.

### BACKGROUND

Various installation and fastening components are known for laying and installing cables or pipes; for example, connectors for attaching cables or pipes to support structures are already widely used. The cables or pipes are often very long, and multiple connectors are needed to work together to form multiple support points along the entire length of the cable or pipe, in order to attach the cable or pipe to the support structure in such a way that it is substantially straight. Generally, the process of installing the cable or pipe is as follows: a row of spaced installation holes is first formed at the installation positions of the cable or pipe, then connectors are respectively installed and fastened in the installation holes, and finally the cable or pipe is installed in cable harness receiving parts of the connectors.

### SUMMARY OF THE INVENTION

However, in the installation process described above, the installation hole positions will often deviate slightly from the longitudinal axis of the cable or pipe, with the result that the cable or pipe is unable to maintain a straight course along the entire length of its longitudinal axis after being installed in the cable harness receiving parts of the connectors. In particular, in the case of harder pipes, this may result in parts of the pipe not being able to be installed in the receiving parts of the connectors.

To solve the abovementioned technical problem, an existing solution is to make the connectors adjustable by means of an additional base. For example, EP2270943 has disclosed fixing a connector to a support structure by means of a foot element, wherein the relative positions of the foot element and the connector are adjustable. However, at the site of the installation work, the use of an additional base to enable adjustment of connector position is inconvenient; an additional process is needed to fix the base, and the connector then needs to be fitted to the base. Furthermore, the separate base and connector also result in higher manufacturing and labour costs.

The present invention provides a connector for attaching a cable or pipe to a support structure, enabling a suitable degree of adjustability of connector installation position in a simple and convenient way.

A connector for attaching a cable or pipe to a support structure, the connector comprising an installation part for fastening to the support structure and a clamping part for supporting the cable or pipe, the installation part comprising a base substantially perpendicular to the fastening direction and a sidewall extending from a side edge of the base substantially in the fastening direction; the installation part further comprises an adapter part, which is used for receiving a fastening component or is directly fastenable to the support structure, and the base is provided with an opening; when the adapter part is fastened to the support structure by means of the fastening component or directly, the adapter part is at least partially installed in the opening, and the base is movable relative to the adapter part along an installation face of the support structure. Thus, the connector of the present invention is fastened to the support structure by means of the adapter part; the base and the clamping part of the connector are not fastened to the support structure directly, and the opening in the base enables the base to move within a certain range relative to the fixed adapter part, thus making the connector position-adjustable, and helping to ensure that the cable or pipe is substantially straight after being attached to the support structure.

According to an embodiment of the present invention, the adapter part comprises an extension part, which extends in the fastening direction and has a cross section perpendicular to the fastening direction that is smaller than the opening, and a stop part, which adjoins the extension part and has a cross section perpendicular to the fastening direction that is at least partially larger than the opening. The extension part smaller than the opening enables the adapter to move within the opening, while the stop part larger than the opening is used to limit the adapter part so that it will not detach completely from the base, to ensure that the connector is able to be connected in its entirety to the support structure by means of the adapter part, while the base is suitably movable along the installation face of the support structure to adjust position.

According to a preferred embodiment of the present invention, the adapter part comprises at least one through-hole for a fastening component to pass through, the fastening component being driven into the support structure through the through-hole by means of a fastening tool, and the adapter part further comprises a receiving part for receiving a nose part of the fastening tool. The adapter part is provided with a through-hole for the fastening component, in order to adapt to various types of fastening component such as screws, bolts, etc. Driving fastening components into a support structure by means of a fastening tool is a common way of installing cables or pipes, so the fact that the adapter part comprises the receiving part for matching the nose part of the fastening tool helps to ensure that the installation process convenient and efficient.

According to another preferred embodiment of the present invention, the adapter part comprises a fastening component at an end of the extension part that faces towards the support structure, and the adapter part can be installed on the support structure directly by means of the fastening component. Thus, the fastening component is part of the adapter part, and the adapter part can be fastened to the support structure directly with no need for an additional fastening component.

According to a preferred embodiment of the present invention, the opening is round, rectangular or obround. Differently shaped openings enable the base to have greater freedom of position adjustment relative to the fastened adapter part, e.g. translation or rotation along the installation surface of the support structure.

According to a preferred embodiment of the present invention, the opening is substantially in the form of a narrow slot, comprising a first side edge and a second side edge which are opposite each other and substantially perpendicular to the direction of extension of the cable or pipe, and two opposite end edges of the narrow slot connecting the first side edge and second side edge. The opening in the form of a narrow slot enables the base to have its position adjusted relative to the fastened adapter part perpendicularly to the direction of extension of the cable or pipe, such that multiple connectors distributed in the direction of extension of the cable or pipe are aligned, thus ensuring that the cable or pipe is straight in the direction of extension thereof.

According to a preferred embodiment of the present invention, the extension part has substantially the same shape as the opening, but a smaller size than the opening overall. Thus, the extension part has a larger range of movement within the opening while helping to ensure stability of the connector.

According to a preferred embodiment of the present invention, the stop part extends at least partially past the first side edge and second side edge in the direction of extension of the cable or pipe, thereby at least partially coinciding with an edge part of the opening. Thus, when the adapter part has been fastened to the support structure, the base is limited by the stop part in such a way as to be only able to move parallel to the plane of the installation surface; the stop part covers the edge part of the opening in the base, ensuring that the base will not break away from the limiting action of the stop part.

According to a preferred embodiment of the present invention, a cut hole is provided in the sidewall of the installation part that is parallel to the first and second side edges, the stop part extends within the cut hole, and the length of the cut hole is substantially equal to the length of the narrow slot. Thus, cooperation between the adapter part and the installation part is achieved simply and effectively.

According to a preferred embodiment of the present invention, an anti-slip structure is provided on a side of the stop part that faces towards the base, and/or on an opening edge part of the first and second side edges of the base. The function of the anti-slip structure is to generate greater friction between the stop part and the base; thus, when the connector has been adjusted to the desired position, the connector will not shift easily due to the friction between the stop part and the base.

According to an embodiment of the present invention, the adapter part is connected to the sidewall by means of at least one flexible strip. Preferably, the at least one flexible strip has a predetermined breaking point of weakened material. Alternatively, the at least one flexible strip is designed as a thin film hinge. The connector of the present invention is a single piece; the adapter part is part of the connector, being integrally formed with the whole of the connector. Once the adapter part has been fastened to the support structure, the flexible connection between the adapter part and the cavity enables the base and clamping part of the connector to move relative to the adapter part, thus greatly facilitating the process of installing and fastening the connector. The integrally formed connector also helps to reduce the manufacturing cost as well as the cost of labour in the installation process.

### BRIEF DESCRIPTION OF THE DRAWINGS

The present invention will be described in more detail by way of the following examples with reference to the accompanying drawings. The described embodiments are only possible configurations in which the individual features may however be implemented independently of each other or may be omitted.

In the drawings:

FIG. 1 is a perspective view of a connector according to an embodiment of the present invention;

FIG. 2 is a schematic drawing showing partial details of the connector shown in FIG. 1.

FIG. 3 is a schematic drawing of the connector shown in FIG. 1, viewed from another angle.

FIG. 4 is a sectional view of the connector shown in FIG. 1.

### DETAILED DESCRIPTION

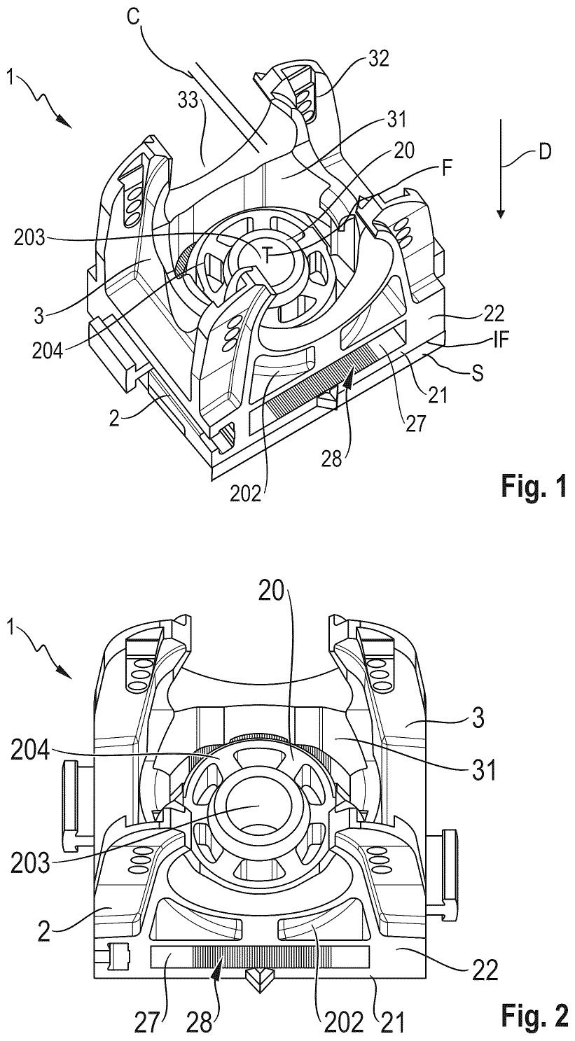

FIGS. 1 to 4 show a connector 1 for attaching a cable (shown solely schematically as C), such as a pipeline, pipe or an electrical cable, etc., to a support structure (not shown solely schematically as S with installation face IF also shown solely schematically), such as a wall, ceiling or steel beam. Preferably, the connector 1 is made of plastic by injection moulding.

The connector 1 comprises an installation part 2 for fastening to the support structure, and a clamping part 3 for supporting the cable or pipe. The installation part 2 comprises a base 21 substantially perpendicular to the fastening direction, sidewalls 22 extending from side edges of the base 21 substantially in the fastening direction, and an adapter part 20 which can receive a fastening component F (shown solely schematically) or can be fastened directly to the support structure.

According to a preferred embodiment of the present invention, the base 21 is substantially rectangular, and in an installed state of the connector 1, a bottom face of the base 21 abuts an installation surface of the support structure. The sidewalls 22, which extend from the side edges of the base 21 in the fastening direction D, enclose a square hollow space in accordance with the outline of the rectangular base. The clamping part 3 extends further from the base sidewalls 22, to enclose a cavity 31 for receiving a nose part of a fastening tool FT (see, e.g. FIG. 4) and clamping arms 32 for clamping the cable or pipe. Preferably, the clamping arms 32 are inclined slightly towards the cavity 31 or angled towards the cavity 31 in an arc shape, so that opposite clamping arms 32 form a slot 33, enabling the cable or pipe to be firmly clamped in the slot 33.

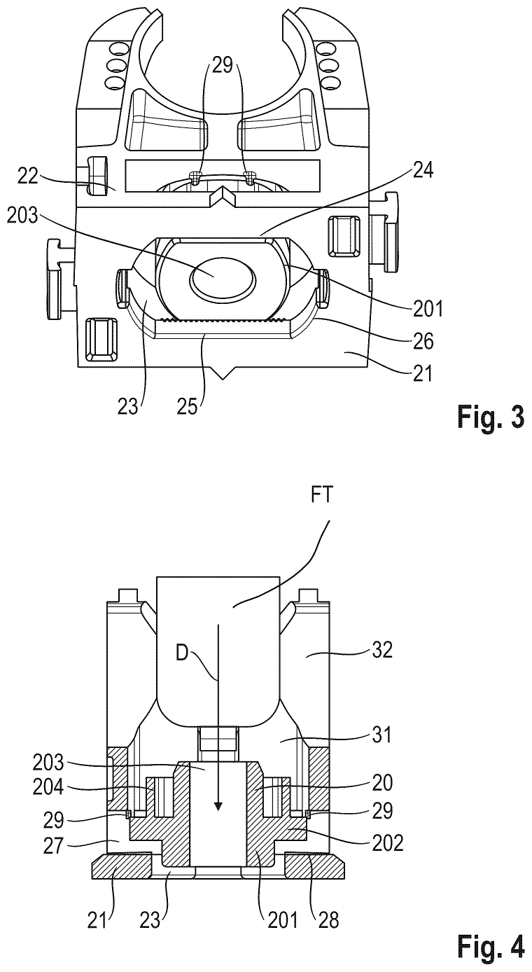

Referring to FIGS. 3 and 4, the base 21 is provided with an opening 23. The adapter part 20 is at least partially installed in the opening 23. Preferably, the opening 23 is in the form of a narrow slot, comprising a first side edge 24 and a second side edge 25 which are opposite each other and substantially perpendicular to the direction of extension of the cable or pipe, and two opposite end edges 26 connecting the first side edge 24 and second side edge 25. This type of opening 23 in the form of a narrow slot enables the base 21 to have its position adjusted relative to the fastened adapter part 20 perpendicularly to the direction of extension of the cable or pipe, such that multiple connectors distributed in the direction of extension of the cable or pipe are aligned, thus ensuring that the cable or pipe is straight in the direction of extension thereof. Preferably, the ends 26 are arc-shaped; the arc-shaped end edges 26 make it possible for the base 21 to rotate along the installation surface, and are better matched to the shape and size of the cavity 31.

Alternatively, the opening 23 has another shape, such as round, rectangular or obround. Differently shaped openings enable the base to have greater freedom of position adjustment relative to the fastened adapter part, e.g. translation or rotation along the installation surface of the support structure. In fact, the shape of the opening 23 depends on the shape of the adapter part and the required freedom of movement of the connector.

The adapter part 20 comprises an extension part 201 (see e.g. FIG. 3), which extends in the fastening direction and has a cross section perpendicular to the fastening direction D that is smaller than the opening 23, and a stop part 202, which adjoins the extension part 201 but has a cross section perpendicular to the fastening direction D that is at least partially larger than the opening 23. The cross section of the extension part 201 perpendicular to the fastening direction is uniform; preferably, the extension part 201 has substantially the same shape as the opening 23, but a smaller size than the opening 23 overall.

The stop part 202 is a flat face lying substantially parallel to the installation surface, i.e. perpendicular to the fastening direction, e.g. a flange face formed by extension radially outwards from the extension part 201. The cross section of the stop part 202 perpendicular to the fastening direction is at least partially larger than the opening 23, i.e. the stop part 202 will not completely enter the opening 23; the stop part 202 at least partially covers an opening edge part of the base 21, and this is necessary to enable the extension part to move relative to the opening 23. At the same time, the stop part 202 covers the edge part of the opening 23 of the base 21, limiting the adapter part 20 so that it will not completely detach from the base 21, to ensure that the connector 1 can still be connected to the support structure by means of the adapter part 20, and the base 21 is limited by the stop part 202 in such a way as to be only able to move parallel to the plane of the installation surface.

According to a preferred embodiment of the present invention, when the opening 23 is in the form of a narrow slot, the stop part 202 extends at least partially past the first side edge 24 and second side edge 25 in the direction of extension of the cable or pipe, thereby at least partially covering the edge part of the opening. Preferably, cut holes 27 are respectively provided in a pair of opposite sidewalls 22 of the installation part parallel to the first side edge and second side edge, and the stop part 202 extends within the cut holes 27. The length of the cut holes 27 is substantially equal to the length of the opening in the form of a narrow slot. The cut holes 27 are formed in the pair of sidewalls 22 perpendicular to the direction of extension of the cable or pipe. Thus, cooperation between the adapter part and the installation part is achieved simply and effectively, and the requirements of mould forming are met; in particular, when the connector 1 is integrally formed, mould release forming is facilitated.

As shown in FIGS. 1 and 2, a number of anti-slip structures 28 are provided on the side of the stop part 202 which faces towards the base 21 and/or on the opening edge part of the base, e.g. multiple ribs arranged in parallel, or uniformly distributed discrete protruding lines, and a sanded surface, etc. The function of the anti-slip structure is to generate greater friction between the stop part and the base; thus, when the connector 1 has been adjusted to the desired position, the connector will not shift easily due to the friction between the stop part 202 and the base 21.

According to a preferred embodiment of the present invention, the adapter part 20 comprises at least one through-hole 203 for the fastening component to pass through. Preferably, the through-hole 203 is located at the centre of the adapter part, i.e. the through-hole 203 runs through the stop part 202 and the extension part 201 in the fastening direction. The fastening component is a screw, or a bolt, or a nail, or another fastener. The shape and size of the through-hole 203 should be adapted to the fastening component used. The through-hole 203 is used for receiving the fastening component, and therefore, the axis of the through-hole 203 should be parallel to the fastening direction D.

When the fastening component is a bolt, it is suitable for a support structure having a pre-formed drilled hole or threaded hole. In this case, the through-hole 203 is preferably also a threaded hole, so that the bolt is screwed into the through-hole 203 and the hole of the support structure, thereby fastening the connector to the support structure.

When the fastening component is a screw, a fastening tool needs to be used. The fastening tool is a direct fastening tool which operates without the need for pre-drilling, such as an electric nailer or an electric screwdriver, for driving the screw into the support structure. A common fastening tool comprises a nose part for installing a screw, and the adapter part 20 thus has a receiving part 204 for receiving the nose part of the fastening tool in order to better match the fastening tool. The size of the receiving part 204 is adapted to the size of the nose part. The receiving part 204 adjoins the stop part 202; the through-hole 203 runs through the receiving part 204, the stop part 202 and the extension part 201. Driving fastening components into a support structure by means of a fastening tool is a common way of installing cables or pipes, so the fact that the adapter part 20 comprises the receiving part 204 for matching the nose part of the fastening tool helps to make the installation process convenient and efficient.

According to another preferred embodiment of the present invention, the side of the extension part 201 of the adapter part 20 that faces towards the support structure comprises a fastening component, e.g. a barbed pin; thus, when the fastening component is installed in an installation hole, the adapter part 20 is fastened to the support structure directly, and there is no need to provide an additional through-hole for the fastening component.

Referring to FIGS. 3 and 4, the adapter part 20 is connected to the sidewall 22 by means of at least one flexible strip 29. The flexible connection of the adapter part 20 to the sidewall 22 enables the base and the clamping part of the connector to move relative to the adapter part, and also helps to lower the manufacturing cost and technology. Preferably, there are two, three or four of the flexible strips 29, distributed in the circumferential direction of the stop part 202. The flexible strip 29 has one end connected to a circumferential edge of the stop part, and another end connected to the sidewall 22. More preferably, when the opening 23 is in the form of a narrow slot, four of the flexible strips 29 are included, arranged in opposite pairs between an upper side edge of the cut hole 27 of the sidewall 22 and an edge of the stop part. Such a structure facilitates demoulding of the one-piece connector 1 in the injection moulding process.

Preferably, the at least one flexible strip 29 has a predetermined breaking point of weakened material. Alternatively, the at least one flexible strip is designed as a thin film hinge. When the base is adjusted after installation or after fixing of the adapter part 20 to the support structure, the flexible strip 29 can break at the predetermined breaking point, so the position of the connector 1 can be adjusted more conveniently. Before the adapter part 20 is fastened to the installation hole, the connector 1 of the present invention is a single piece; the adapter part 20 is part of the installation part, being integrally formed with the installation part 2 and the clamping part 3. When the adapter part 2 has been fastened to the support structure, an end face of the extension part 201 of the adapter part and the bottom face of the base 21 simultaneously abut the installation surface of the support structure; since the extension part 201 is smaller than the range of the opening, while the stop part 202 presses on the opening edge part of the base, the base 21 can be suitably moved along the installation surface, e.g. in parallel or rotated slightly. Thus, in the process of installing the cable or pipe, even if the installation holes have not been aligned in a straight line, the positions of the bases 21 can be suitably adjusted so that the clamping parts 3 of the multiple connectors remain aligned, due to the fact that the adapter parts are fixed in the installation holes, and the bases and adapter parts can move relative to each other within the range of the openings. Thus, the one-piece connector of the present invention greatly facilitates the process of fitting and fastening the cable or pipe to the support structure.

Although the present invention has been described with reference to its preferred embodiments, it will be understood by those skilled in the art that various changes may be made and equivalents may be substituted for components of the present invention without departing from the true spirit and scope thereof. In addition, many modifications may be made to adapt to particular situations or materials taught by the present invention without departing from the essential teachings of the present invention.

What is claimed is:

1-13. (canceled)

14. A connector for attaching a cable or pipe to a support structure, the connector comprising:
an installation part for fastening to the support structure in a fastening direction; and
a clamp part for supporting the cable or pipe,
the installation part having a base perpendicular to the fastening direction, a sidewall extending from a side edge of the base in the fastening direction, and an adapter part for receiving a fastener or directly fastenable to the support structure, the base being provided with an opening;
when the adapter part is fastened to the support structure by the fastener or directly, the adapter part is at least partially installed in the opening, and the base is movable relative to the adapter part along an installation face of the support structure.

15. The connector as recited in claim 14 wherein the adapter part has an extension part extending in the fastening direction and has a cross section perpendicular to the fastening direction that is smaller than the opening, and a stop part adjoining the extension part and having a cross section perpendicular to the fastening direction that is at least partially larger than the opening.

16. The connector as recited in claim 15 wherein the adapter part has at least one through-hole for the fastener to pass through, the fastener being driven into the support structure through the through-hole by a fastening tool, and the adapter part further includes a receiving part for receiving a nose part of the fastening tool.

17. The connector as recited in claim 15 wherein that the adapter part has a fastening component at an end of the extension part facing towards the support structure, and the adapter part is directly fastenable to the support structure by the fastening component.

18. The connector as recited in claim 14 wherein the opening is round, rectangular or obround.

19. The connector as recited in claim 14 wherein the opening is in the form of a narrow slot, including a first side edge and a second side edge opposite each other and perpendicular to a direction of extension of the cable or pipe, and two opposite end edges connecting the first side edge and second side edge.

20. The connector as recited in claim 19 wherein the extension part has a same shape as the opening, but a smaller size than the opening overall.

21. The connector as recited in claim 20 wherein the stop part extends at least partially past the first side edge and second side edge in the direction of extension of the cable or pipe, thereby at least partially coinciding with an edge part of the opening.

22. The connector as recited in claim 21 wherein a cut hole is provided in the sidewall, the stop part extending within the cut hole, and a length of the cut hole being equal to the length of the narrow slot.

23. The connector as recited in claim 22 further comprising an anti-slip structure on a side of the stop part facing towards the base, or on an opening edge part of the first side edge and second side edge of the base.

24. The connector as recited in claim 14 wherein the adapter part is connected to the sidewall by at least one flexible strip.

25. The connector as recited in claim 24 wherein the at least one flexible strip has a predetermined breaking point of weakened material.

26. The connector as recited in claim 24 wherein the at least one flexible strip is designed as a thin film hinge.
